(19) United States
(12) Patent Application Publication
(10) Pub. No.: US 2026/0056915 A1
(43) Pub. Date: Feb. 26, 2026

(54) METHOD AND SYSTEM FOR ANALYZING RADIO FREQUENCY IDENTIFICATION (RFID) DATA

(71) Applicant: Accenture Global Solutions Limited, Dublin (IE)

(72) Inventors: Mallikarjun Bepeta, Atlanta, GA (US); Rajul Agarwal, BANGALORE (IN); Gautham Sampangirama Reddy, Eden Prairie, MN (US)

(21) Appl. No.: 18/810,868

(22) Filed: Aug. 21, 2024

(51) Int. Cl. G06F 16/11; G06K 7/10

(52) U.S. Cl. CPC G06F 16/116; G06K 7/10306

(57) ABSTRACT

The present disclosure relates to a method of real-time analysis of RFID data. The method includes hosting an application program interface (API) at a computer system located at a retail location. The computer system receives RFID tag data from RFID tag connected to objects at a first and a second frequency. The computer system also receives additional data describing the objects from a remote location. Thereafter, the received RFID tag data and the additional data is analyzed and stored in a first format. Based on the analyzed data, a first inquiry, in first format, is transmitted from the API to a backend system. A first response, in second format is received from the backend system by the API. The first response is then converted into to the first format, by the API. The method additionally includes analyzing data and updating the analyzed data with information from the received first response.

### FIELD OF THE INVENTION

Various embodiments described herein relate generally to radio frequency identification (RFID) data analysis. Specifically, a computer implemented method and a system for real-time processing and analysis of the accessed RFID data.

### BACKGROUND

Radio frequency identification (RFID) is a form of automatic identification and data capture (AIDC) technique. RFID is recently being used in a wide range of areas such as Supply Chain Management (SCM), health care, traffic monitoring, retail, and access control. The ability to store large amounts of data and identify objects which are not in the line of sight has given RFID technology an edge over other automatic identification approaches such as the barcode based systems and optical character recognition systems. As an example, RFID technology integration in SCM systems has resulted in the reduced losses and improved visibility in various stages of supply chaining, reduced numbers of data entry errors, efficient inventory management, and lower human labor costs in distribution centers.

### SUMMARY

Implementations of the present disclosure are generally directed to Radio Frequency Identification (RFID) data analysis. More particularly, implementations of the present disclosure are directed to a computer implemented method and a system for real-time processing and analysis of RFID data collected from objects in retail stores and from remote location(s).

In general, innovative aspects of the subject matter described in this specification provide a method for facilitating communication between RFID reader in retail store location, backend applications and remote servers in remote locations. The method leverages artificial intelligence (AI) for real-time processing and analysis of RFID data. The method includes hosting an application program interface (API) at a computer system located at a retail location. The computer system receives RFID tag data from RFID tag connected to objects proximate to the retail location. The RFID tag data transmitted to the computer system may include data transmitted at a first frequency compatible with and received by the API and at a second frequency incompatible with the API. Moreover, the API receives additional data describing the objects and/or support operations for the retail location. Thereafter, the computer system analyzes the received RFID tag data and the additional data, to generate analyzed data, stored in a first format. Based on the analyzed data, the method includes transmitting a first inquiry from the API to a backend system, the inquiry being in the first format. Thereafter, the API receives a first response to the first inquiry from the backend system, the first response is in a second format different from the first format. The received first response in second format is converted to the first format by the API. The analyzed data is then updated with information from the received response.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 illustrates an example environment that may be used to execute implementations of the present disclosure.

FIG. 2 illustrates a flow diagram that presents an example system for real-time processing and analysis of RFID tag data in accordance with implementations of the present disclosure.

FIG. 3 illustrates an example system architecture of RFID API in accordance with implementations of the present disclosure.

FIG. 4 illustrates the flow diagram of an example method for authentication and data access of the RFID API 106, in accordance with implementations of the present disclosure.

FIG. 5 illustrates a computer system that may be used to implement the RFID API Management Module 268 in accordance with implementations of the present disclosure, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

RFID technology has gained greater prominence and a higher level of adoption due to its recent advancements and decreasing costs across the years. Radio frequency identification (RFID) is used in fashion industry, manufacturing, inventory control, warehousing, distribution, logistics, materials and garment tracking, shopper purchasing behavior, and supply chain management. RFID tag are placed on objects so that they can be uniquely identified. These objects in motion are traced throughout the supply chain from manufacturer's shop floor, to warehouses, to retail stores. Such a visibility of accurate data brings opportunities for improvement and transformation in various processes of the supply chain and allows a wide range of organizations to realize significant productivity gains and efficiencies.

There are technical problems in the widespread use of RFID in various retailers and manufacturers using traditional methods. Different systems from various vendors supports different protocol formats and technologies, and thus the existing RFID systems struggle to connect with existing backend systems and applications. Inconsistency in standards creates compatibility issues, where RFID systems, software, and tags from different vendors do not cooperate in data exchange. This lack of standardization prevents synchronizing the diverse types of RFID data generated by these various systems with existing backend infrastructure, such as inventory management or point-of-sale systems. Further, inability of RFID software from different vendors to communicate creates data silos and hinders information flow. Additionally, achieving optimal read rates within fitting rooms remains a challenge. This limited functionality translates to a lack of real-time data availability. Integrating different RFID systems therefore requires custom development and interface modifications due to vendor-specific protocols, thereby creating a dependency on a particular vendor, and for which a custom solution can become inoperable if one the backend systems changes its protocols.

Furthermore, stores often lack the technology to convert raw RFID tag data into actionable insights that can be used to optimize operations or enhance the user experience. As a result, the valuable data collected by RFID reader is often underutilized. In the traditional RFID systems, tasks like inventory management are performed using manual processes like barcode scanning, which are prone to human error. Further, the lack of adequate security measures can also expose RFID backend systems to potential security breaches, as any user with a compatible reader could access the information stored on the tag. Addressing these standardization, integration, security, and privacy challenges is essential for the retail industry to fully realize the potential benefits of RFID technology. While some vendors offer APIs for RFID data access, Bluetooth beacon tracking, and software customization, these capabilities are currently limited. They often only work with the vendor's specific RFID devices and may not offer the full range of functionalities needed for comprehensive solutions.

In view of this, implementations of the present disclosure propose a radio frequency identification (RFID) application program interface (API), powered by artificial intelligence (AI), that acts as a bridge between various RFID systems (tags, readers, backend systems), applications, and cloud environments (private, public, SaaS). This allows for seamless data exchange and real-time operations, using AI. The need for custom integrations for every different RFID system is eliminated, thereby, saving resources and promoting flexibility. Moreover, the present disclosure provides a central point for managing and controlling all aspects of RFID system, thereby, administration and streamlines operations. The proposed solution ensures consistent updates between backend systems and the RFID database, guaranteeing accurate and up-to-date data. Additionally, the proposed solution facilitates seamless integration with existing RFID systems and other in-store data sources, regardless of their location within the network, resulting in comprehensive data collection and analysis.

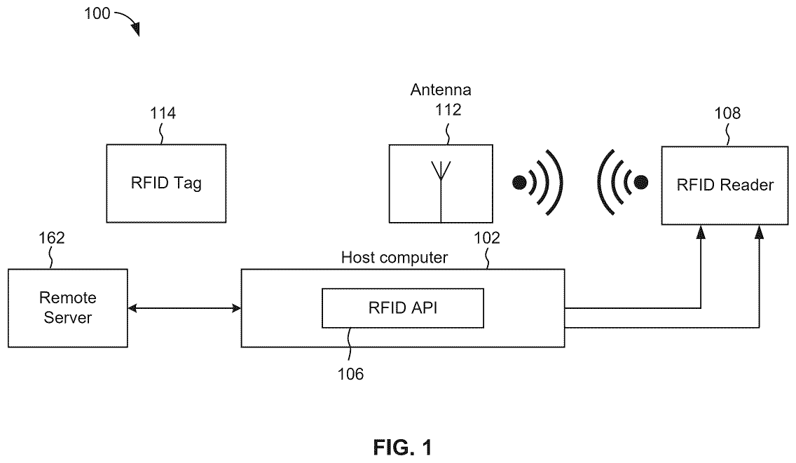

FIG. 1 illustrates an example environment 100 that may be used to execute implementations of the present disclosure. In the example of FIG. 1, the example environment 100 includes one or more RFID tag 114, an antenna 112, a host computer 102, a RFID reader 108 and a remote server 162.

Each of the RFID tag 114 are devices attached to the objects in the retail stores. The RFID tag 114, once activated, transmits data of the object to the host computer 102, via RFID reader 108. The RFID tag 114 includes a semiconductor chip (not shown in the figure) and an antenna 112 basically. The semiconductor chip stores the data of the object to which it is attached. For instance, the data stored on the semiconductor chip includes unique identification number, product information, or the like, of the object. Further, the RFID tag 114 may be passive or active working type. The passive tags are activated from the electromagnetic field of the RFID reader 108, while the active tags activated via own battery.

The RFID reader 108 is a network connected device that reads data of the object and transmit it to the host computer 102. The RFID reader 108 emits radio signals and reads the data from the RFID tag 114. The RFID reader 108 may be portable or permanently attached. For example, portal RFID reader (typically installed at store entrances or exits), tunnel RFID reader (typically installed near fitting rooms or cashier points) and on-shelf RFID reader (typically installed on shelves or displays), Bluetooth RFID reader, or the like. The RFID reader 108 transmits and receive radio signals, a radio frequency (RF).

The host computer 102 hosts the RFID application program interface (API) 106 for the processing of RFID data. The host computer 102 can be a computer system that receives RFID data from the RFID reader 108 and enable the RFID API 106 to perform real time analysis of RFID data.

The RFID reader 108 transmits radio signals, in a specific frequency range. The RFID tag 114, within the specific range of the transmitted radio signals, receive the radio signal, gets activated. The RFID tag 114, after being activated, transmits the data stored on semiconductor chip, to the RFID reader 108. The RFID reader 108 transmits the data to the host computer 102 for performing real-time analysis of data via RFID API 106. Further, in the depicted example environment, the remote server 162 is provided to exchange data from the host computer 102.

Various examples depicting real-time analysis and processing of RFID data, are described in detail in conjunctions with figures below.

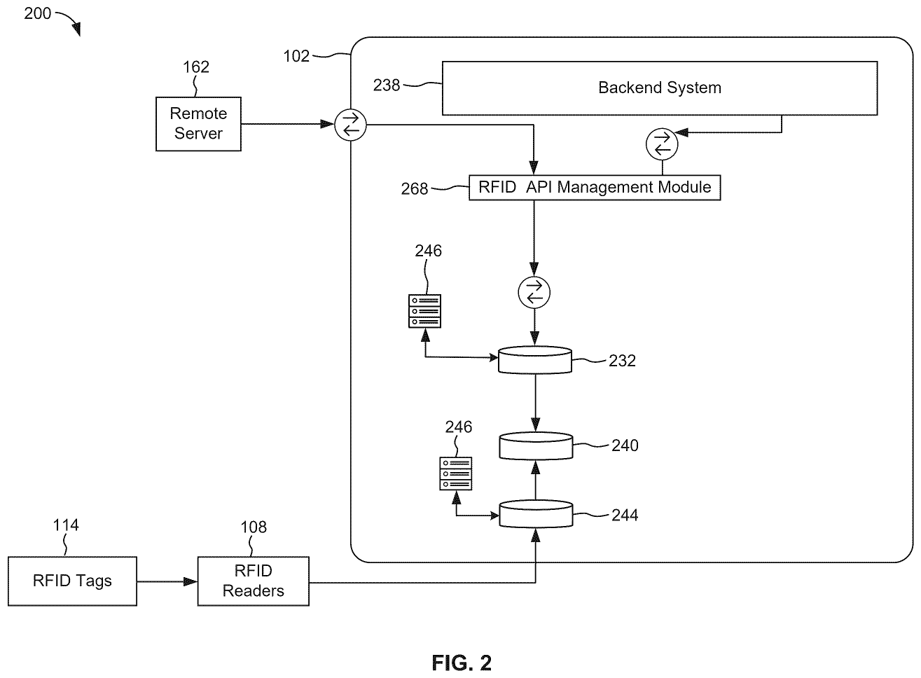

FIG. 2 illustrates a flow diagram that presents an example system for real-time processing and analysis of RFID tag data in accordance with implementations of the present disclosure. Herein, the FIG. 2 is described in conjunction with FIG. 1.

The RFID reader 108 reads RFID tag data from one or more RFID tag 114 connected to objects proximate to the retail location. The RFID edge server 246 is provided to receive RFID tag data from the RFID reader 108. Specifically, the RFID edge server 246 performs real-time processing and analysis of accessed RFID data, reasoning decision making, and integrating with the retail applications via RFID API 106. The RFID edge server 246 captures the RFID tag data and performs first level of filtering. The filtered data is then stored in a database 244.

Specifically, the computing system receive the RFID tag data at a first frequency that may be compatible with and received by the API and at a second frequency incompatible with the API. For example, the first frequency can be a low frequency (LF) radio signal that is compatible the RFID API 106 and the second frequency can be an ultra-low frequency (ULF) that is incompatible with network protocols of the RFID API 106. Herein, the RFID API 106 identifies the second frequency as data received from a tampered RFID tag.

After collecting the RFID data, the RFID edge server 246 performs quality control, data sanitization and logical separation by using techniques, including verification, filtering, aggregation, caching, and transformation. Specifically, the RFID edge server 246 ensures the integrity and validity of the data received from the RFID reader 108. For example, the RFID edge server 246 verifies the data formats of the RFID tag data. The RFID edge server 246 may filter out unwanted data based on pre-defined criteria. For example, the RFID edge server 246 may filter RFID tag data outside a specific zone or belonging to a specific product category. Furthermore, the RFID edge server 246 may aggregate or combine data from one or more RFID tag 114 into a single record. The aggregation may involve summarizing RFID tag 114 counts within a specific area or calculating average read times. The caching may include storing frequently accessed of data from RFID tag 114 on the data base 240 for faster retrieval, thereby causing faster retrieval of information. The RFID edge server 246 may transform the RFID tag data into a format that is more suitable for further processing by the backend systems. The transformation may involve parsing data from the RFID tag 114, converting units, or enriching the data with additional information from local databases.

Thereafter, the RFID edge server 246 performs data auditing of the RFID tag data and store the audited data in database 232. The auditing ensures that an RFID tag attached to each object provides the information of every object.

Thereafter, the RFID edge server 246 routes the RFID data to an RFID application program interface (API) management module 268. The RFID API management module 268 acts as a platform for analyzing the received RFID tag data, transmitting enquiries to backend systems and receiving responses from backend systems. The backend system 238 may include existing retail enterprise and applications used in retail stores, such as Enterprise Resource Planning (ERP), Warehouse Management System (WMS), and Supply Chain Management (SCM) systems.

Moreover, the RFID API 106 receives additional data describing the objects and/or support operations for the retail location from the remote server 162. The remote server 162 may include, but not limited to, one or more retail enterprise cloud service provider (CSP), RFID systems, software, and tags from different vendors of retails store, and other in-store data sources.

The remote server 162 and the backend system 238 requires an access token for authentication and data access of the RFID API 106.

After analyzing the RFID tag data and additional data, the RFID API management module 268 transmits first inquiry to the backend system, wherein the first inquiry is in first format. Further, the RFID API management module 268 receives a first response to first inquiry from the backend system 238, wherein the first response is in a second format. The RFID API management module 268 converts the response received in second format into first format. Finally, the RFID API management module 268 updates the analyzed data with information from the received first response.

Further, the RFID API management module 268 transmits a second inquiry based on the updated analyzed data to the backend system 238. Herein, the second inquiry is in the first format. the RFID API management module 268 receives a second response from the backend system 238. Herein, the second response is in a third format different from the first format and the second format. The RFID API management module 268 converting the second response from the third format to the first format and updates the analyzed data with information from the second response.

Furthermore, the RFID API management module 268 receives a third enquiry from the backend system. Herein, the third enquiry is in the second format. The RFID API management module 268 converts the third inquiry from the second format to the first format. The RFID API management module 268 determines a first answer to the third inquiry based on the updated analyzed data and transmits the first answer in the first format from the RFID API 106 to the backend system 238.

Moreover, the RFID API management module 268 receives a fourth enquiry from the backend system. Herein, the fourth enquiry is in the third format. The RFID API management module 268 converts the fourth inquiry from the third format to the first format. The RFID API management module 268 determines a second answer to the fourth inquiry based on the updated analyzed data and transmits the second answer in the first format from the RFID API 106 to the backend system 238.

For an instance, the backend system 238 may include of multiple components from different vendors, each utilizing its own data format. The RFID API management module 268 initiates a enquiry to a specific backend system (for example, A) from a different vendor. Since A uses a different format, the RFID API management module 268 converting the data from the RFID API management module's 268 format to the format processed by A. For example, the RFID API management module 268 receives a user login request in JSON format. However, A, a legacy system from another vendor, process data in a fixed-length record format. The RFID API management module 268 converts the user credentials (username, password) from the JSON format to a fixed-length record before sending it to A for authentication. Thereafter, A successfully authenticates the user from the previous enquiry and sends a response with user details. Since the RFID API management module 268 process data in JSON format, A converts the response (including user details) from its internal format to JSON before sending it back.

In another example, the RFID API management module 268 receives a product order request in XML format. A system B, a newer inventory management system, process data in a proprietary data format. The RFID API management module 268 converts the product details (ID, quantity) from XML to B's format before sending it for inventory check and order processing. Thereafter, B confirms the product availability based on the RFID API management module 268 request and sends response. The response converts from B's internal format to the RFID API management module 268 format (e.g., JSON) before being returned.

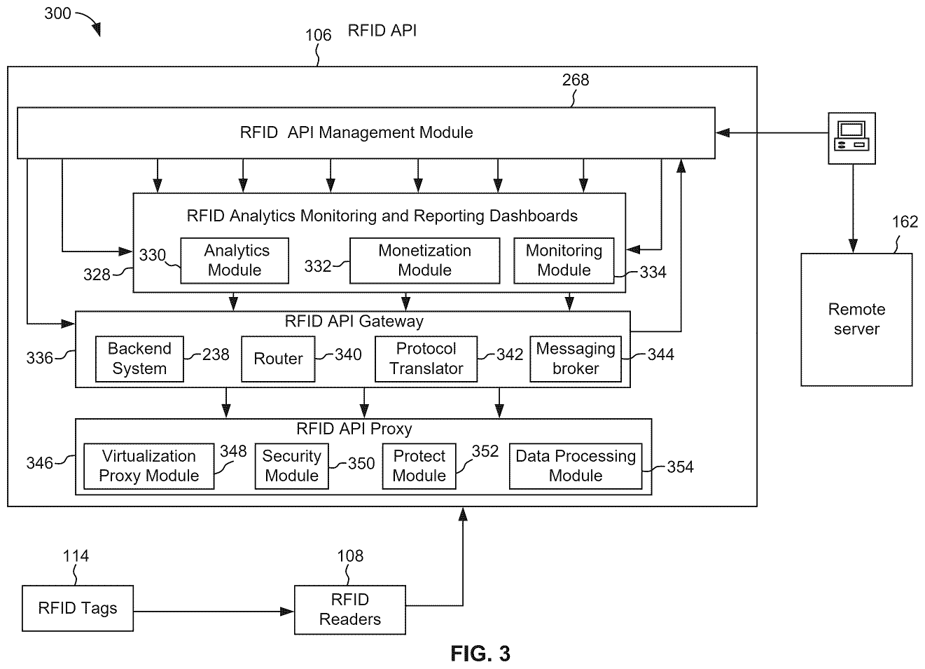

FIG. 3 illustrates an example system architecture of RFID API 106 including components for real-time analysis of RFID data in accordance with implementations of the present disclosure. The RFID API 106 includes the RFID application program interface (API) management module 268, an RFID analytics & monitoring reporting dashboard module 328, RFID API gateway 336 and RFID API proxy 346. Herein, the FIG. 3 is described in conjunction with FIG. 1 and FIG. 2

The host computer 102 in the retail store hosts the RFID API 106 on a platform, for example, edge platform. Moreover, various retail store's in-house backend retail enterprise applications run at the host computer 102. The retail enterprise applications are provided to streamline operations, optimize inventory levels, and improve overall performance. For an instance, retail enterprise applications include, but not limited to, Enterprise Resource Planning (ERP), Warehouse Management System (WMS), Supply Chain Management (SCM) and back-office and legacy applications (for example, Customer Relationship Management (CRM), Point-of-Sale (POS), financial accounting, or the like).

The RFID API 106 receives RFID tag data of the object in the retail store from RFID tag 114. Further, the RFID API 106 receives additional data describing the objects from at least one remote server 162 from a remote location. Various retail enterprise applications like, but not limited to, ERP, WMS and SCM runs at the remote server 162. The remote server 162 may include, but not limited to, one or more retail enterprise cloud service provider (CSP), RFID systems, software, and tags from different vendors of retails store, and other in-store data sources.

Specifically, the RFID API 106 integrates the RFID tag data received from the retail store and additional data describing the objects with retail enterprise and applications running on retail stores and remote server 162 or/and CSP, to perform real time analysis of RFID data.

The RFID API gateway 336 receives RFID tag data from RFID tag 114 connected to objects proximate to the retail location. Further, the RFID API gateway 336 is provided to capture, filter and store the RFID tag data. The RFID API gateway 336 is middleware component between the RFID reader 108 and retail enterprise and applications running on retail stores and remote server 162 or/and CSP. RFID API gateway 336 transmits RFID data requests to the appropriate retail enterprise and application. In simpler words, the RFID API gateway 336 facilitate communication between RFID reader 108 and retail enterprise and application like ERP, WMS and SCM.

Moreover, the RFID tag data is transmitted at a first frequency compatible with RFID API 106 and at a second frequency incompatible with the RFID API 106. For an instance, the first frequency can be a low frequency (LF) radio signal that is compatible with network protocols of the RFID API 106 in the retail store. The RFID tag data transmitted at the first frequency can be analyzed by the RFID API management module 268. The RFID tag data of an apparel in a retail store, transmitted at the first frequency includes, but not limited to, unique identifier, size, color, and brand.

Further, in another instance, the second frequency can be an ultra-low frequency (ULF) that is incompatible with network protocols of the RFID API 106. For example, if the RFID tag 114 connected to objects is tampered, it transmits the ULF which is unable to be authenticate by RFID reader 108. In such case, the RFID API 106 can then access other information about the objects, such as the brand name stored in the retail store's database. By analyzing the similar data for other objects of the same brand (size, color, etc.), the RFID API 106 can predict the missing data of the tampered object.

The RFID API gateway 336 further includes a backend system 238, a router 340, a protocol translator 3342 and a massaging broker 344. The backend system 238 represents existing retail enterprise and applications used in retail stores, such as Enterprise Resource Planning (ERP), Warehouse Management System (WMS), and Supply Chain Management (SCM) systems. The backend system 238 store and manage data related, but not limited to, inventory, sales, and logistics. The router 340 directs incoming data inquiries to the appropriate backend application based on their purpose. The backend system 238 use different communication protocols. The protocol translator 3342 translates data between the format used by the RFID reader 108 and the formats used by the backend applications, thereby ensuring seamless communication. The massaging broker 344 is a central message hub provided to facilitate communication between different parts of the system by routing messages efficiently.

The RFID API gateway 336 interacts with RFID API proxy 346, which further includes a virtualization proxy module 348, a security module 350, a protect module, and a data processing module 354. The virtualization proxy module 348 is provided for deploying the RFID API 106 platform on virtual machines, thereby, making it scalable and adaptable to different network configurations within stores. The security module 350 protects the RFID system from unauthorized access and data breaches by using features like, but not limited to, secure access control, data encryption, and intrusion detection. The protect module 352 is provided to protect to the backends in the event of high demand on the managed APIs, such as-setting up a cache to request the backend only in the case of a new request or data update on the backend. The data processing module 354 is provided for preparation and transformation of RFID tag data for use by AI algorithms.

After receiving RFID tag data from the RFID API gateway 336, the RFID tag data is transmitted to the RFID API management module 268 for further processing.

After receiving the RFID tag data and additional data, RFID API management module 268 analyze the data which is stored in a first format. The RFID API management module 268 is a software component designed to maintain, publish, and manage RFID API 106 throughout their entire life cycle. This provides a unified interface in front of a RFID API gateway 336 and backend applications and system, enhancing usability and providing loose coupling. This allows to maintain and change the location of the backend application components with no impact to the retailer.

Moreover, RFID API management module 268 provides a centralized and unified method of deploying and reusing developed assets integrations across RFID reader 108 and backend applications, sharing RFID API documentation, and keeping API services secure. Additionally, it controls the tasks that include RFID API schemas and publishing them, providing secure access to the RFID APIs, controlling the traffic that passes through the APIs back and forth from RFIDs data to backend applications, real-time error tracking of RFID APIs and providing real-time notifications of any anomalies with the RFIDs readers data, regular monitoring of usage analytics and improving the RFID APIs, and providing a unified developer experience.

This RFID API management module 268 also includes a developer portal and tools for application development teams to customize as needed, such as RFID API catalogs with unified catalog features that help other developers understand the various partner providers and internally developed APIs so that they do not duplicate efforts. The RFID API management module 268 supports popular API specifications such as, but not limited to, OpenAPI, WSDL, JSON, and XSD schemas to automatically create and update docs with retail industry-standard metadata, self-service key management, and easily re-usable API templates for developers to consume as needed.

After analysing the RFID tag data and additional data, the RFID API management module 268 transmits first inquiry, wherein the first inquiry is in first format. Further, the RFID API management module 268 receives a first response to first inquiry, wherein the first response is in a second format. The RFID API gateway 336 converts the response received in second format into first format. Finally, the RFID API management module 268 updates the analyzed data with information from the received first response.

For example, the applications running at the remote server 162 typically use the REST (Representational State Transfer) protocol for communication. REST is a popular web service standard that uses HTTP requests and responses with JSON or XML data formats. The applications running at the backend system 238, like ERP (Enterprise Resource Planning), WMS (Warehouse Management System), SCM (Supply Chain Management), and others may utilize different protocols and data formats for communication. For example, backend applications support data formats like SOAP (Simple Object Access Protocol), or flat file formats (text files with specific delimiters). The RFID API gateway 336 intercepts REST calls from the applications running at the remote server 162. The REST calls include data or instructions related to RFID data processing or analysis. Thereafter, the RFID API gateway 336 converts the REST calls into data format that are compatible with the applications running at the backend system 238. This eliminates the need for developers to modify the internal systems, thereby, saving time and resources.

The RFID analytics monitoring and reporting dashboard module 328 is provided to display analytics and reports generated from the RFID tag data and additional data. These reports can include insights into inventory levels, customer behavior, or potential security threats. More specifically, the RFID analytics monitoring and reporting dashboard module 328 include an analytics module 330, a monetization module 332 and a monitoring module 334.

The analytics module 330 collects RFID reader 108 data from RFID API gateway 336 endpoints and visualizes it. The analytics module 330 collects and analyzes data from discrete backend application systems using the RFID API proxy 346, including average response time, request size, total traffic, and more. This can also be categorized to see more specific insights, such as traffic errors back and forth for individual RFID reader 108 data and retail stores applications. The monetization module 332 generates potential revenue streams from the use of the platform or the data it analyzes. The monitoring module 334 is provided for real-time monitoring of information about RFID reader 108 data and application integrations, as well as data performance and regular updates into backend RFID systems and applications, allowing problems to be identified and resolved quickly. When the fault threshold is exceeded for the RFID's, the retail operations team is notified via an alert feature integrated with the communication channel.

The RFID API 106 of the present disclosure can be deployed at various network levels within retail stores, including access, aggregation, retail SaaS apps, and enterprise cloud. The proposed solution employs minimalistic virtual machines that are scalable, easily deployable, and can be migrated at various levels of the network within the stores.

The RFID API 106 leverages artificial intelligence (AI) to perform real-time processing and analysis of RFID tag data. The RFID API 106 automates the deployment of machine learning (ML) algorithms on a platform at retail locations. on the platform. The platform can be edge located near the retail location. Further, the deployment of machine learning (ML) algorithms may include deployment of one or more pre-trained ML models for performing tasks relevant to retail, such as, anomaly detection (unusual tag activity) or location tracking (customer movement). The RFID API 106 interacts with RFID tag 114 attached to objects near the retail location and collects RFID data through RFID reader 108 for further processing and analysis. The RFID data is analyzed by ML algorithms deployed on the platform. The analysis by ML algorithms may include assigning one or more labels (categories or classifications) to the RFID data to specify the context, thereby, allowing the ML model to make accurate analysis. Further, the RFID API 106 tests the RFID tag data against one or more machine learning models based on task requirements. The best performing ML models are retrieved, sorted, and stored locally in a shared repository for future use by developers. After analysis, the analyzed RFID data may upload to the remote server 162, such as, cloud service provider (CSP). For example, the CSP may include Amazon Web Services or Microsoft Azure.

Upon the receipt of enquiry, the RFID API 106 deploy and run ML algorithms. Furthermore, the RFID API 106 captures information about the deployed ML algorithms'effectiveness (e.g., accuracy, performance metrics). The captured information may then transfer back to the CSP to facilitate continuous learning and improvement of the ML models.

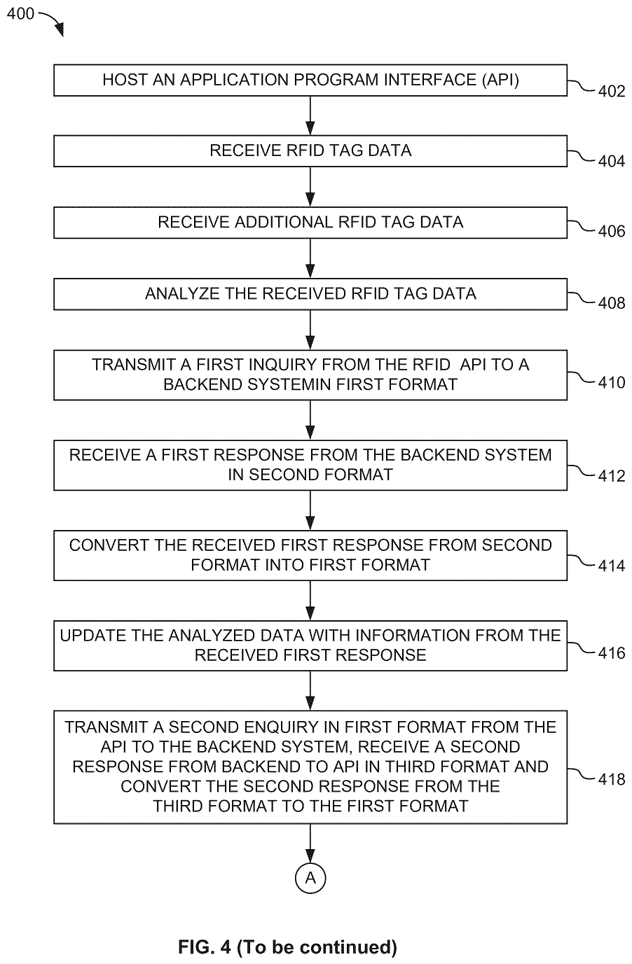

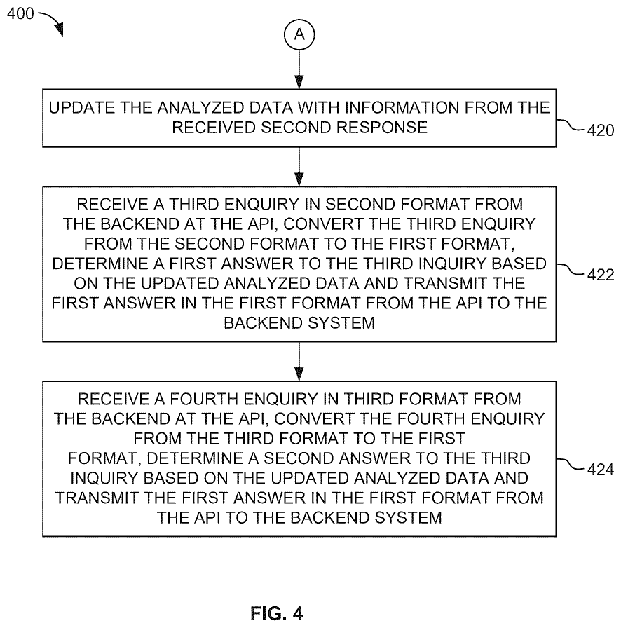

FIG. 4 is a flow diagram that presents an example method 400 of a real-time processing and analysis of RFID tag data collected from objects in retail stores in accordance with implementations of the present disclosure. In some implementations, the method 400 may be executed within the RFID application program interface (API) 106 as described in relation to FIG. 1 and FIG. 2.

At step 402, the method includes hosting the Radio Frequency Identification (RFID) application program interface (API) 106 at a host computer 102 located at a retail location. For instance, a computer system at the retail store hosts the RFID API 106 on a platform, for example, edge.

At step 404, the method includes receiving RFID tag data connected to objects proximate to the retail location, by the host computer 102. The RFID reader 108 collects and reads data from the RFID tag 114 connected to the objects in the retail stores and transmit the data to the host computer 102. The RFID reader 108 are devices that emit radio signals to read data from RFID tag 114 attached to the objects in the retail store and transmit the data to RFID API 106, via RFID API 106.

For instance, the RFID tag 114 on an object store data of object to which the RFID tag 114 is attached. For example, the data may include unique identification (UID). The RFID tag 114 transmits the data to RFID API 106.

Moreover, the RFID tag 114 transmits the RFID tag data at a first frequency compatible with RFID API 106 and at a second frequency incompatible with the RFID API 106. For example, the first frequency can be a low frequency (LF) radio signal that can be read by RFID reader 108 and is compatible with the RFID API 106. Furthermore, the second frequency can be an ultra-low frequency (ULF) that may be unable to be read by RFID reader 108 and is incompatible with the RFID API 106. Upon receiving the second frequency, RFID API 106 can access other information about the similar other objects to predict the missing data.

At step 406, the method includes receiving additional data describing the objects and/or support operations for the retail location from the remote server 162 of at least one remote location. For example, retail store vendors and the retail store vendor providers send the additional data like facility-specific data, suppliers, consignments, pallets, cases, and objects in xml framework.

For instance, the RFID API management module 268 receives the additional data (for e.g. object name, price and current stock level) describing the object from the remote server 162 (for e.g. central database).

At step 408, the method includes analyzing the RFID tag data and additional data by RFID API management module 268, wherein the data is stored in a first format. For instance, the RFID API management module 268 analyzes the RFID tag data (object's ID number) and the additional data (for e.g. object name, price and current stock level).

At 410, the method includes transmitting the first inquiry in first format. The RFID API management module 268 transmits the first inquiry based on the analyzed data to the backend system 238. Further, the first inquiry is transmitted in the first format. For example, the first inquiry transmitted is “What is the stock level of the object”. The first inquiry transmitted is in first format and can be processed by the backend system 238. For an instance, the first inquiry transmitted is in RESTful format (data format supported by REST protocol).

At 412, the method includes receiving a first response to first inquiry, wherein the first response is in a second format. The RFID API management module 268 receives a first response from the backend systems of remote server 162 or from the backend system 238 in the retail store, after the processing of first inquiry. For an instance, the first response is received in JSON format.

For instance, in response to the first inquiry (in RESTful format) “Is there a promotion running for the object”, the backend systems respond with the first response, for example, “Stock level of the object is five hundred units”, in second format (in JSON format).

At 414, the method includes converting the received first response in second format i.e. JSON format, into first format i.e. RESTful format. The RFID API 106 receives the first response in second format and converts into first format for further analysis.

At step 416, the method includes updating the analyzed data with information from the received first response. The RFID API management module 268 incorporates the information from the first response into the existing analyzed data. For instance, the RFID API updates the analyzed data (for example, object name) with information from the received first response (for example, Stock level of the object is five hundred units). This allows the retail store to display the information on a nearby screen or provide it to staff assistants.

At step 418, the method includes transmitting a second enquiry in first format from the RFID API management module 268 to the backend system 238, receiving a second response from backend system 238 to RFID API management module 268, in third format and converting the second response from the third format to the first format.

Further, at step 420, the method includes, updating the analyzed data with information from the received second response.

At step 422, the method includes receiving a third enquiry in second format from the backend at the RFID API management module 268, converting the third enquiry from the second format to the first format, determining a first answer to the third inquiry based on the updated analyzed data and transmitting the first answer in the first format from the RFID API management module 268 to the backend system 238.

Furthermore, at step 424, the method includes receiving a fourth enquiry in third format from the backend at the RFID API management module 268, converting the fourth enquiry from the third format to the first format, determining a second answer to the third inquiry based on the updated analyzed data and transmitting the first answer in the first format from the RFID API management module 268 to the backend system 238.

The above methodologies provide a technical solution to the above identified technical problems with the context real-time processing and analysis of RFID tag data collected from objects in retail stores. The proposed solution utilizes an RFID API 106, as the interface to facilitate data format translation. Therefore, the RFID API provides seamless data exchange between various RFID systems (tags, readers, vendors), backend systems (inventory management, WMS, SCM), and remote server applications (POS, cloud apps) regardless of the specific vendor or technology and eliminating the need for custom integrations for each vendor. Even if backend system changes its protocol, or is substituted, the translation functionality of the API will continue to allow all systems to cooperate as intended.

In another example, RFID tag 114 on an object, for example, red shirt, is detected by the RFID reader 108. The RFID reader 108 sends the RFID tag data (for example, product ID) at first frequency which is compatible with RFID API 106. The RFID API 106 may also receive additional data about the shirt (for example, current price) in a separate database from the remote server 162. The RFID API 106 compares the RFID tag (product ID) with the additional data (current price) and performs an initial analysis. After the initial analysis RFID API identifies the object as a red shirt with a specific price. Based on this analysis, the RFID API 106 sends an inquiry to the backend system 238 asking for any promotions or restocking needs related to the shirt (using the first format, for example in RESTful format). The backend system may respond with a discount offer for the red shirt and suggest checking stock levels (using the second format, for example in JSON format). The RFID API 106 converts the received response in second format to first format and updates the analyzed data to include the discount information and potential stock requirement. Furthermore, if the RFID reader 108 sends the RFID tag data (for example, product ID) at second frequency, the RFID API 106 identifies it to be tampered received data and thus can predict the missing data by analyzing the similar data for other objects of the same brand (size, color, etc.).

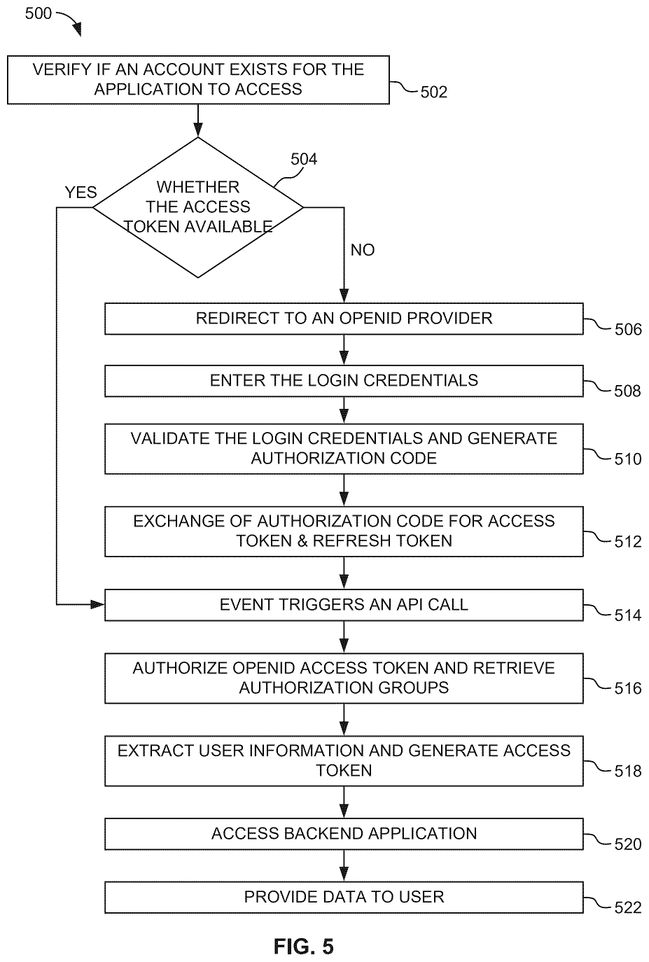

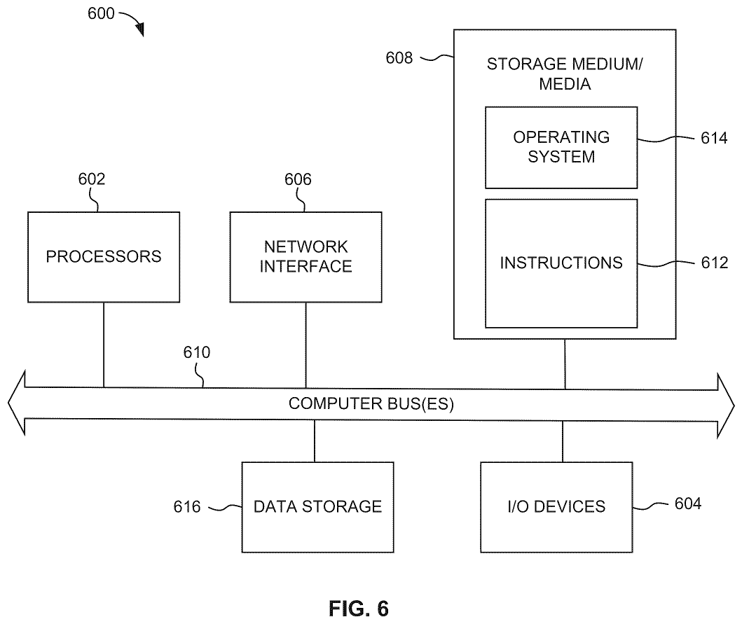

FIG. 5 illustrates the flow diagram of an example method for generation of the access token for authentication and data access of the RFID API 106. Herein, the FIG. 5 has been described in conjunction with the FIG. 1, FIG. 2 and FIG. 3.

At step 502, the method includes verifying if the application requesting access to the RFID API has a valid account, thereby ensuring that the application is recognized.

At step 504, the method includes verifying the availability of an access token. The access token refers to a code that grants permission to access the RFID API 106 temporarily. Further, the access token ensures that only authorized applications can communicate with the RFID API 106 and protects the RFID data from unauthorized access.

If the access token is unavailable, the method, at step 506, includes redirecting to an OpenID provider for authentication and initiate a request for user authentication. The OpenID provider typically includes a login page where the login credentials are entered.

At step 508, the method includes entering login credentials for the application attempting to access the RFID API 106. The login credentials may include a username and password combination.

Thereafter, at step 510, the method includes validation of login credentials by the OpenID provider. Further, the OpenID provider verifies if the application is authorized to request an access token. If validation is successful, an authorization code is provided to the application.

At step 512, the authorization code is exchanged for a pair of tokens: an access token and a refresh token (for example, POST/auth2/v1/token). The access token and a refresh token enable the application to interact with the RFID API 106. For example, the application exchanges the authorization code for access and refresh tokens.

At step 514, the application triggers an event that requires an RFID API 106 to be accessed. The event may include providing an OpenID access token.

Thereafter, at step 516, the RFID API Gateway 336 authorizes the OpenID access token and retrieves the associated user's authorization groups. The authorization groups determine the level of access that can be granted to the RFID API's 106 resources.

At step 518, the user information is extracted, and an access token is generated. Specifically, based on the validated access token and retrieved user information, a new access token is generated. The access token may incorporate specific permissions or scopes required for RFID API 106 to be accessed.

At step 520, the generated access token is used to authenticate and authorize the application's request to access the RFID API 106.

At step 522, data is then relayed back to the user through the application and the RFID API management module 268. Specifically, the RFID API 106 processes the request, retrieves the requested data, and returns it to the application. The data is then presented to the user through the RFID API management module 268.

Specifically, the proposed solution with the RFID API 106 provides flexible, scalable, and cost-effective approach to RFID integration compared to traditional systems. The proposed solution simplifies data management, reduces vendor lock-in, and enable advanced data analytics through the AI functionalities within the RFID API 106.

FIG. 6 illustrates a computer system 600 that may be used to implement the RFID API 106. More particularly, computing machines such as desktops, laptops, smartphones, tablets, and wearables which may be used to implement the tasks that may have the structure of the computer system 600. The computer system 600 may include additional components not shown and that some of the process components described may be removed and/or modified. In another example, a computer system 600 may be deployed on external-cloud platforms such as cloud, internal corporate cloud computing clusters, organizational computing resources, and/or the like.

The computer system 600 includes processor(s) 602, such as a central processing unit, ASIC (application specific integrated circuit) or another type of processing circuit, input/output devices 604, such as a display, mouse keyboard, etc., a network interface 606, such as a Local Area Network (LAN), a wireless 802.11x LAN, a 3G or 4G mobile WAN or a WiMax WAN, and a computer-readable medium 608. Each of these components may be operatively coupled to a bus 610. The computer-readable medium 608 may be any suitable medium that participates in providing instructions to the processor(s) 602 for execution. For example, the computer-readable medium 608 may be non-transitory or non-volatile medium, such as a magnetic disk or solid-state non-volatile memory or volatile medium such as RAM. The instructions or modules stored on the computer-readable medium 608 may include machine-readable instructions 612 executed by the processor(s) 602 that cause the processor(s) 602 to perform the methods and functions of the RFID API 106.

The RFID API 106 may be implemented as software stored on a non-transitory processor-readable medium and executed by the processors 602. For example, the computer-readable medium 608 may store an operating system 614, such as MAC OS, MS WINDOWS, UNIX, or LINUX, and code for the RFID API 106. The operating system 614 may be multi-user, multiprocessing, multitasking, multithreading, real-time, and the like. For example, during runtime, the operating system 614 is running and the code for the RFID API 106 is executed by the processor(s) 602.

The computer system 600 may include a data storage 616, which may include non-volatile data storage like RFID edge server 246. The data storage 616 stores any data used or generated by the RFID API 106.

The network interface 606 connects the computer system 600 to internal systems for example, via a LAN. Also, the network interface 606 may connect the computer system 600 to the Internet. For example, the computer system 600 may connect to web browsers and other external applications and systems via the network interface 606.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method, comprising:
hosting an application program interface (API) at a computer system located at a retail location;
receiving, at the computer system, RFID tag data from RFID tag connected to objects proximate to the retail location, including data transmitted at a first frequency compatible with and received by the API and at a second frequency incompatible with the API;
receiving, at the computer system from at least one remote location, additional data describing the objects and/or support operations for the retail location;
analyzing the received RFID tag data and the received additional data to generate analyzed data stored in a first format;
transmitting a first inquiry, based on the analyzed data, from the API to a backend system, the inquiry being in the first format;
receiving, at the API, a first response to the first inquiry from the backend system, the first response being in a second format different from the first format;
converting the received first response from the second format to the first format; and
first updating the analyzed data with information from the received first response.

2. The method of claim 1, wherein the backend system is at least partially present in an internet cloud remote from the computer system of the retail location.

3. The method of claim 1, further comprising:
transmitting, from the API to the backend system, a second inquiry based on the updated analyzed data, the second inquiry being in the first format;
receiving, at the API, a second response from the backend system, the second response being in a third format different from the first format and the second format;
converting the second response from the third format to the first format; and
second updating the analyzed data with information from the second response.

4. The method of claim 1, wherein the first frequency is a low frequency that is compatible with network protocols of the API.

5. The method of claim 1, wherein the second frequency us an ultra-low frequency that is incompatible with network protocols of the API.

6. The method of claim 1, further comprising:
receiving, at the API from the backend system, a third inquiry, the third inquiry being in the second format;
converting the third inquiry from the second format to the first format;
determining a first answer to the third inquiry based on the updated analyzed data; and
transmitting the first answer in the first format from the API to the backend system.

7. The method of claim 6, further comprising:
receiving, at the API from the backend system, a fourth inquiry, the fourth inquiry being in the third format;
converting the fourth inquiry from the third format to the first format;
determining a second answer to the fourth inquiry based on the updated analyzed data; and
transmitting the second answer in the first format from the API to the backend system.

8. A non-transitory computer readable media comprising instructions that when executed on a process cause a computer system to perform operations comprising:
hosting an application program interface (API) at a computer system located at a retail location;
receiving, at the computer system, RFID tag data from RFID tag connected to objects proximate to the retail location, including data transmitted at a first frequency compatible with and received by the API and at a second frequency incompatible with the API interface;
receiving, at the computer system, from at least one remote location, additional data describing the objects and/or support operations for the retail location;
analyzing the received RFID tag data and the received additional data to generate analyzed data stored in a first format;
transmitting a first inquiry, based on the analyzed data, from the API to a backend system, the inquiry being in the first format;
receiving, at the API, a first response to the first inquiry from the backend system, the first response being in a second format different from the first format;
converting the received first response from the second format to the first format; and
first updating the analyzed data with information from the received first response.

9. The non-transitory computer readable media of claim 8, wherein the backend system is at least partially present in an internet cloud remote from the computer system of the retail location.

10. The non-transitory computer readable media of claim 8, the operations further comprising:
transmitting, from the API to the backend system, a second inquiry based on the updated analyzed data, the second inquiry being in the first format;
receiving, at the API, a second response from the backend system, the second response being in a third format different from the first format and the second format;
converting the second response from the third format to the first format; and
second updating the analyzed data with information from the second response.

11. The non-transitory computer readable media of claim 8, wherein the first frequency is a low frequency that is compatible with network protocols of the API.

12. The non-transitory computer readable media of claim 8, wherein the second frequency us an ultra-low frequency that is incompatible with network protocols of the API.

13. The non-transitory computer readable media of claim 8, the operations further comprising: receiving, at the API from the backend system, a third inquiry, the third inquiry being in the second format;
converting the third inquiry from the second format to the first format;
determining a first answer to the third inquiry based on the updated analyzed data; and
transmitting the first answer in the first format from the API to the backend system.

14. The non-transitory computer readable media of claim 13, the operations further comprising:
receiving, at the API from the backend system, a fourth inquiry, the fourth inquiry being in the third format;
converting the fourth inquiry from the third format to the first format;
determining a second answer to the fourth inquiry based on the updated analyzed data; and
transmitting the second answer in the first format from the API to the backend system.

15. A system, comprising:
a processor;
a non-transitory computer readable media comprising instructions programmed to cooperate with the processor to cause the system to perform operations comprising:
hosting an application program interface (API) at a computer system located at a retail location;
receiving, at the computer system, RFID tag data from RFID tag connected to objects proximate to the retail location, including data transmitted at a first frequency compatible with and received by the API and at a second frequency incompatible with the API interface;
receiving, at the computer system from at least one remote location, additional data describing the objects and/or support operations for the retail location;
analyzing the received RFID tag data and the received additional data to generate analyzed data stored in a first format;
transmitting a first inquiry, based on the analyzed data, from the API to a backend system, the inquiry being in the first format;
receiving, at the API, a first response to the first inquiry from the backend system, the first response being in a second format different from the first format;
converting the received first response from the second format to the first format; and
first updating the analyzed data with information from the received first response.

16. The system of claim 15, wherein the backend system is at least partially present in an internet cloud remote from the computer system of the retail location.

17. The system of claim 15, the operations further comprising:
transmitting, from the API to the backend system, a second inquiry based on the updated analyzed data, the second inquiry being in the first format;
receiving, at the API, a second response from the backend system, the second response being in a third format different from the first format and the second format;
converting the second response from the third format to the first format; and
second updating the analyzed data with information from the second response.

18. The system of claim 15, wherein the first frequency is a low frequency that is compatible with network protocols of the API.

19. The system of claim 15, wherein the second frequency us an ultra-low frequency that is incompatible with network protocols of the API.

20. The system of claim 15, the operations further comprising:
receiving, at the API from the backend system, a third inquiry, the third inquiry being in the second format;
converting the third inquiry from the second format to the first format;
determining a first answer to the third inquiry based on the updated analyzed data; and
transmitting the first answer in the first format from the API to the backend system.
